(19) United States
(12) Patent Application Publication
(10) Pub. No.: US 2011/0246308 A1
(43) Pub. Date: Oct. 6, 2011

(54) Method and system for managing interactive communications campaigns with preference management

(76) Inventors: Timothy R. Segall, Lexington, MA (US); Dennis Turri, Burlington, MA (US)

(21) Appl. No.: 12/753,158

(22) Filed: Apr. 2, 2010

(51) Int. Cl. G06Q 30/00; G06F 9/44; G06F 15/16; G06Q 10/00

(52) U.S. Cl. 705/14.66; 719/328; 709/203

(57) ABSTRACT

A preference management component for a hosted communications campaign system is shared among different types of permitted user roles (e.g., administrators, customer service representatives, and consumers) and enables those users to define and maintain a set of consumer preferences or attributes related to communication by the system. The platform uses a common database schema and display formats for the various users, but the user's ability to define, view and manage given preferences is role-based. Using the platform, permitted users define and manage consumer preferences and events and subscriptions associated therewith. To facilitate extensibility and customization, a service provider client can define and manage a set of extended preference data attributes.

### BACKGROUND

1. Technical Field

This disclosure relates generally to a method and system for managing interactive communication campaigns over a computer network, such as the Internet.

2. Description of the Related Art

It is known to provide a web-based hosted solution through which business entities create and manage interactive or notification communications campaigns. An example of an interactive communications campaign is a telephone campaign to determine whether a target recipient desires to transfer a credit card balance to a new account, a campaign to remind a recipient that a credit card payment is due and to offer the recipient an opportunity to speak with a customer representative concerning any payment issues, or the like. The hosted solution typically is implemented as an application (or “managed”) service provider. One or more business entities (“clients”) that desire to use the service typically register and access the service through an on-line (e.g., web-based) portal. In one representative use scenario, the managed service provider entity provides outbound telemarketing services on behalf of participating clients. The campaign typically is provisioned by the client. Thus, for example, using a web-based interface, a participating client defines a script for the campaign, imports a set of contacts, and defines one or more parameters that govern how the campaign is to be run. At a designated time, the service provider initiates the campaign, e.g., by providing the contacts to a set of telephone servers that set-up and manage the telephone calls to the targets of the campaign. During a given outbound voice call, as noted above, a recipient (a “customer”) may be afforded an option to connect to a contact center, e.g., to speak to a customer representative. In such implementations, the hosted solution typically is integrated directly with the contact center's on-premises automatic call distributor (ACD).

### BRIEF SUMMARY

A preference management component for a hosted communications campaign system is shared among different types of permitted user roles (e.g., administrators, customer service representatives, and consumers) and enables those users to define and maintain a set of consumer preferences or attributes related to communication by the system. The platform uses a common database schema and display formats for the various users, but the user's ability to define, view and manage given preferences is role-based. Using the platform, permitted users define and manage consumer preferences and events and subscriptions associated therewith. A preference or attribute is an element of information associated with a consumer. A contact point defines a mode of communication to the consumer. An event is an occurrence of which a consumer may wish to be notified. A subscription is an association between a customer contact point and an event. To facilitate extensibility and customization, a service provider client can define and manage a set of extended preference data attributes.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 is a block diagram of a service provider infrastructure for implementing a managed communications campaign service;

FIGS. 2A-2B illustrates how an interactive communications campaign is created and managed in the service provider infrastructure illustrated in FIG. 1;

FIG. 3 is a block diagram of the preference management component of this disclosure;

FIG. 4 is a representative display screen for the customer service representative;

FIG. 5 is a representative display screen for the CSR to facilitate additional actions;

FIG. 6 is a representative display screen for use by a CSR to perform a search;

FIG. 7 is a representative display screen to enable a CSR to add contact points;

FIG. 8 is a representative display screen of a consumer view;

FIG. 9 is a representative display screen for use in managing subscriptions;

FIG. 10 is a representative display screen for the CSR interface in an alternative embodiment; and

FIG. 11 is a representative display for the consumer view in the alternative embodiment.

### DETAILED DESCRIPTION

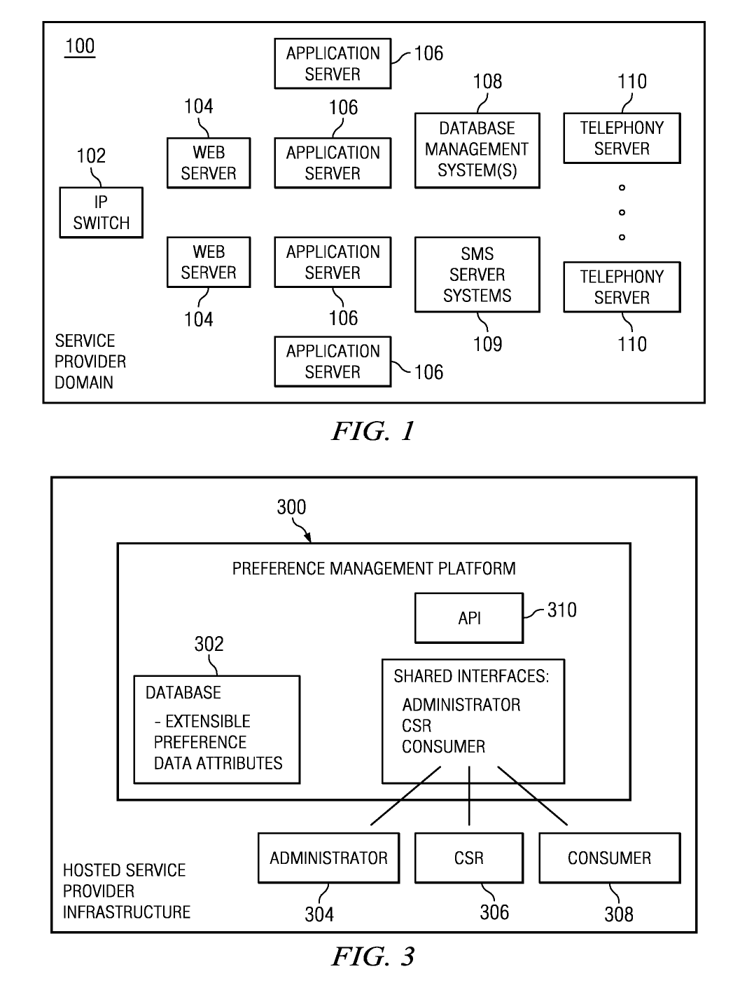

FIG. 1 illustrates a representative service provider or system architecture, which in the preferred embodiment is implemented in or across one or more data centers. A data center typically has connectivity to the Internet. The system provides a web-based hosted solution through which business entities create and manage communications campaigns. Campaigns may be interactive or non-interactive. Representative campaigns include, without limitation, account renewal campaigns, balance transfer or consolidation offer campaigns, billing issue campaigns, credit card activation campaigns, fraud alert campaigns, payment or past due reminder campaigns, customer survey campaigns, debt recovery campaigns, late payment with right party verification campaigns, payment reminder with direct connect to contact center campaigns, appointment reminder campaigns, welcome campaigns, account renewal campaigns, affinity cross-sell/rewards program campaigns, crisis management/disaster recovery campaigns, new product offer campaigns, inquiry/web follow-up campaigns, contract renewal campaigns, service availability notification campaigns, promotional offer campaigns, service delivery confirmation campaigns, and the like. The particular type of campaign is not a limitation or feature of the invention.

A business entity (a “client”) user has a machine such as a workstation or notebook computer. Typically, a business entity user accesses the service provider architecture by opening a web browser on the machine to a URL associated with a service provider domain. Access may also be through an automated process, such as via a Web services application programming interface (API). Where a web browser is used, the client authenticates to the managed service in the usual manner, e.g., by entry of a username and password. The connection between the business entity machine and the service provider infrastructure may be encrypted or otherwise secure, e.g., via SSL, or the like. Although connectivity via the publicly-routed Internet is typical, the business entity may connect to the service provider infrastructure over any local area, wide area, wireless, wired, private or other dedicated network. As seen in FIG. 1, the service provider architecture 100 comprises an IP switch 102, a set of one or more web server machines 104, a set of one more application server machines 106, a database management system 108, a set of SMS message servers 109, and a set of one or more telephony server machines 110. A representative web server machine 104 comprises commodity hardware (e.g., Intel-based), an operating system such as Linux, and a web server such as Apache 2.x. A representative application server machine 106 comprises commodity hardware, Linux, and an application server such as WebLogic 10.3 (or later). The database management system 108 may be implemented as an Oracle (or equivalent) database management package running on Linux. A representative telephony server machine is an application server that implements appropriate software applications for call set-up, voice processing, and other call connection and management activities. An application may implement the Media Resource Control Protocol (MRCP). In the alternative, a telephony server machine may execute an application server in conjunction with one or more PSTN, VoIP and/or voice processing cards that provide interconnectivity for telephone-based calling applications. In a card-based embodiment, a representative card is a CG 6565 (or variant) series available from Dialogic, or an equivalent. Typically, a voice processing application port or card has a finite number of supported ports. In a high volume call environment, there may be several web server machines, several application server machines, and a large number of telephony server machines. Although not shown in detail, the infrastructure may include a name service, FTP servers, MRCP (Media Resource Control Protocol) servers, load balancing appliances, other switches, and the like. Each machine typically comprises sufficient disk and memory, as well as input and output devices. The software environment on each machine includes a Java virtual machine (JVM) if control programs are written in Java. Generally, the web servers 104 handle incoming business entity provisioning requests, and they export a management interface that is described in more detail below. The application servers 106 manage the basic functions of generating campaign scripts, managing contacts, and executing campaigns. As will be discussed below, the campaign may provide end users voice messages, text messages, email messages, or combinations thereof. For voice messaging, the telephony servers 110 handle most telephony-related functions including, without limitation, executing outbound calls and forwarding calls to a contact center. The particular hardware and software implementation details described herein are merely for illustrative purposes are not meant to limit the scope of the present invention.

In a representative embodiment, a typical machine in the service infrastructure is a processor-based server running Linux, and the server includes a telephone interface. A typical interface has up to 240 ports, and each port may be considered a separate telephone line. There are typically a set of such servers operating at a given location (e.g., an Internet data center). The following is a typical operation of the voice messaging service. Using a Web browser or the Web service API, a client provisions a campaign, provisioning a script to be played to a target customer. The scope and content of the script will depend on the campaign. The client also provides the service provider with contact information for a set of persons, who are the target recipients of the campaign. In operation, the system batches a subset of those contacts to one of the machines in the server farm. A control routine executing on the machine takes a first contact in the subset and assigns the contact to an available port. The script is then initiated and the interface card initiates a call over a port. When the recipient's phone is answered, the system determines whether a human being has answered the call (as opposed to an answering machine, a fax, or the like). If a human being has answered, the script plays a set of prompts (basically a set of scripted questions). During the call, if the target recipient takes a given action, a direct-connect (DC) function is initiated. In particular, the system places the call on hold, opens up a separate line to a contact center telephone number (typically provisioned by the client), waits for an agent to respond, places the responding agent on hold, and then bridges the customer to the agent. The system then disconnects. In an alternative, the DC function may take place whether or not the recipient actively initiates it, e.g., by just having the system inform the recipient to “please hold” while the connection to the contact center is established by the service provider.

The contact center may be owned, operated or managed by a third party. The service provider may manage the agents directly. A representative contact center includes automatic call distribution (ACD) functions. As is well-known, an ACD is a computer-implemented and controlled telephone system that distributes calls to contact center agents equitably and gathers statistics about the agents. When the service provider controls and/or manages the agents directly, the provider infrastructure may include a dialer, which is an automatic telephone dialing system. A dialer initiates outbound call from a list of telephone numbers, turns a call over to an agent when a human being responds, and gathers statistics about agents. Such ACD and dialer technologies are well-known.

Using the service provider infrastructure, a business entity can create, execute and manage a message (voice, text, email, or combination) campaign. As noted above, a campaign may have associated therewith one or more “sub-campaigns.” Using a Web interface, a client loads a list of contacts who will be called and associates that list with a script. A “sub-campaign” refers to one or more passes through a contact list that has been bound to a script and that has been associated with a given timeframe. Thus, a “sub-campaign” associates at least the following items: a list of contacts, a script, and a timeframe. Additional details regarding sub-campaigns are set forth below. As noted above, a script determines what will happen during a contact (e.g., an outbound voice call). Typically, a script is formatted as XML and (in a voice message scenario) specifies a sequence of audio prompts that are played and what happens when the recipient takes certain actions such as pressing a button on the phone or speaking a response. As noted above, a direct-connect to the contact center may be carried out automatically (merely when the system determines that the call has been answered by other than an answering machine) and thus the script may designate this functionality.

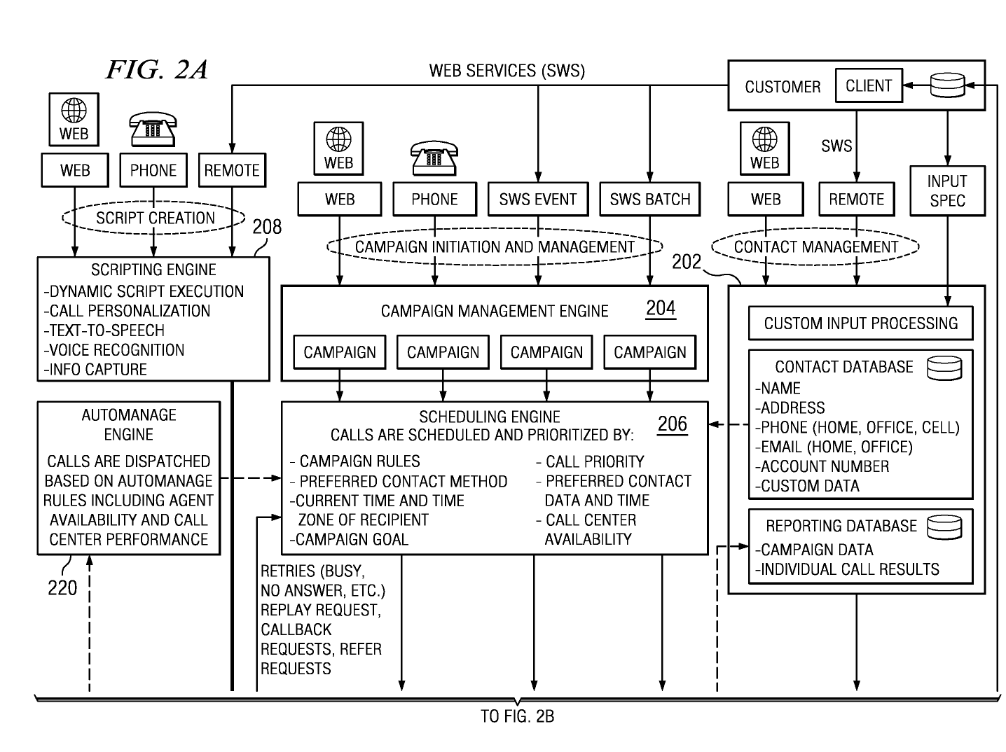

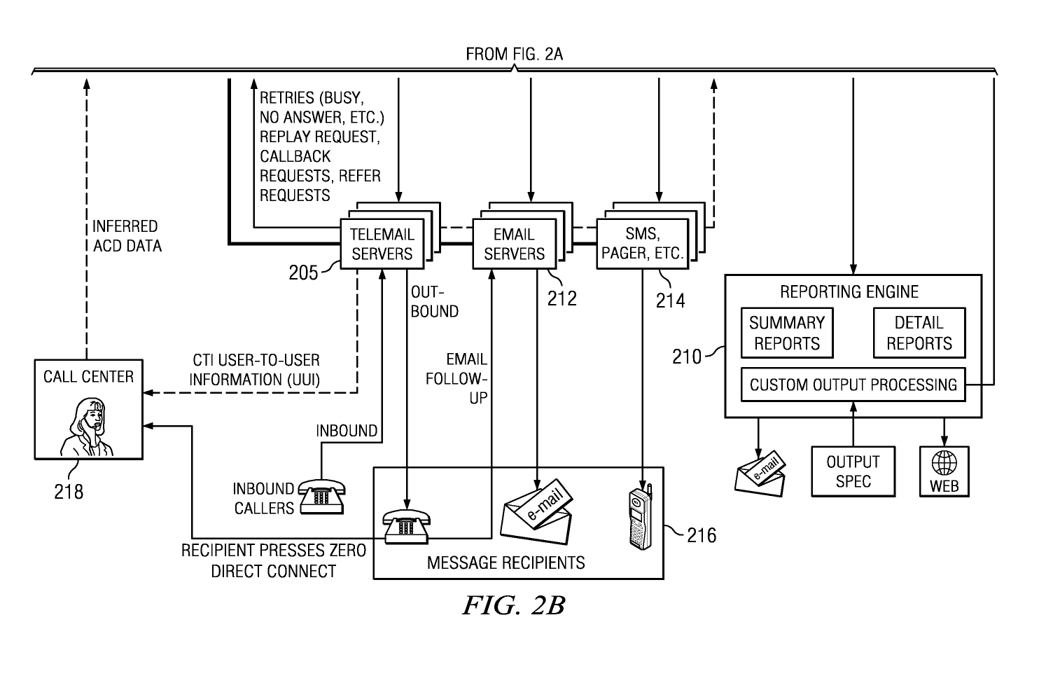

One or more contact lists are stored in a contact database, and typically a contact list comprises a set of contacts. A contact typically is an individual in the contact database, and this individual is sometimes referred to as the “customer” (as, technically, the individual is a customer of the client using the managed service). A contact can include home, work or cell numbers, a client identifier, an email address, or the like. Also, contacts typically include first name, last name, company and other information. With reference to FIGS. 2A-2B, and as described above, a business entity connects to the service provider, authenticates, and then uses one or more applications to create, execute and manage the campaign. These applications execute on the application server machines and operate in association with one or more databases that are supported within the database management system. These applications include, for example, a contact management application 202, a campaign management engine 204, a scheduling engine 206, and a scripting engine 208. The contact management application 202 handles the receipt and storage of the contact list(s) uploaded (e.g., via FTP or otherwise) to the system by or on behalf of the business entity client. The scripting engine 208 handles the creation and managing of the campaign scripts, using instructions entered by or on behalf of the business entity client via a web-based interface or Web services API. The campaign management engine 204 manages the campaign by interoperating with the scheduling engine 206, which in turn interoperates with the telephony servers 205 to execute the campaign. The business entity client evaluates or monitors the campaign from summary, detail and/or custom reports generated by a reporting engine application 210. Campaign evaluation and monitoring may also be performed via a Web-based user interface, or in an automated manner via an API. Notification campaigns are executed using email servers 212 and SMS (or MMS) servers 214, or by other means, such as by telephone.

As also illustrated in FIGS. 2A-2B, after connecting an outbound call to a target customer 216, the customer may elect to be connected to the contact center 218 (typically a third party contact center) or the system may perform that direct-connect automatically once it determines that a human being (as opposed to an answering machine) has answered the outbound call. (An end user may also send a message (e.g., an SMS) to the system). The system typically obtains information about the contact center's performance during a given communications campaign, commonly without requiring a direct connection between the infrastructure and a contact center's on-premises ACD. This enables the managed service provider to integrate with both its business entity clients and with their associated contact center environments rapidly and efficiently. The interconnectivity between the managed service provider and the contact center may be “inferred” from how calls that originate from the service provider to the target recipients (who have expressed an interest in being connected to the contact center) are actually handled. This “indirect” connectivity is illustrated in FIG. 2 by the control engine 220, which can be provided in software as a set of software instructions executable on a processor. In the voice messaging scenario, the engine is responsible for dispatching messages at an appropriate rate while ensuring that all customer-requested rule parameters (as described below) are honored. Examples of such parameters include: number of agents available at the contact center, maximum hold time at the contact center, client abandon rate prior to speaking to a contact center, number of bad numbers reached on the outbound dial, and so forth. Generally, for a given client campaign or sub-campaign, the engine 220 decides on an initial message dispatch rate based on the client-requested parameters (and, optionally, on historical data from like campaigns or sub-campaigns). Once the campaign or sub-campaign, as the case may be, starts running, the engine 220 monitors the parameters and ensures that they remain within tolerance. If an identified parameter exceeds the client-defined value, then a system action rule (e.g., adjusting the message dispatch rate, suspending the sub-campaign, or the like) is applied and any client notification requested is issued. Additional details regarding the functionality of the engine 220 are described in U.S. Publication No. 2007/0172050, which is commonly-owned.

As noted above, preferably a web-based interface is provided to enable a business entity client to create a set of one or more management rules that, when triggered during the campaign, cause the infrastructure (and, in particular, certain control applications therein) to take certain control actions in real-time, preferably based on campaign performance. A campaign may include several preset strategies that a client may choose to change based on day of week or time of day.

As used herein, the following terms have the associated meanings. As noted above, a “campaign” refers to an overall series of messages to a contact list using one or more sub-campaigns that use a given script. Campaigns also act as templates for the sub-campaigns that are created under them. A campaign typically has a preset configuration that applies to all of its sub-campaigns. As noted above, a “sub-campaign” refers to one or more passes through a contact list using a script and that is constrained to a particular timeframe (or at a set of one or more such times). A sub-campaign typically runs under an existing campaign. A “script” as noted above determines what happens during a customer interaction (e.g., a phone call for a voice campaign). Commonly, the script specifies (for a voice call) a sequence of audio prompts that are played to a client (an end user who receives a call) and what happens (the contact center connection) when the recipient takes certain actions (such as pressing a button on the phone or speaking an answer to a query). The script may also specify other actions, such as effecting a contact center connection automatically when detecting that a human being has answered. The nature and type of actions set forth in a script thus may be quite varied, and this disclosure is not limited to any particular process flow within a script.

An “agent” typically is a contact center operator. A “skill group” is a set of agents that are trained to handle a given script. In one embodiment, a skill group defines the number of agents who are scheduled to be on duty at various times of the day on various days of the week, as well as the phone number to use to contact those agents. A skill group can be shared across multiple sub-campaigns or over multiple physical facilities (e.g., telephone numbers). A script may cause the routing of direct-connect calls to different skill groups based on the path through the script. A client of the service may assign a skill group to a sub-campaign when it creates the sub-campaign, whereupon the agents in that skill group are then responsible for handling any incoming messages for that sub-campaign. Agents in a skill group become “live” according to a schedule or upon login to the service provider. Thus, in one embodiment a “live” agent is an agent that has been registered with the service provider, e.g., using a supervisor dashboard or a contact center schedule. An “unallocated” agent is an agent that is not yet allocated to a sub-campaign. An “allocated” agent is an agent that is allocated to a sub-campaign. A “busy” agent is an agent currently assisting a client. An “available” agent is an agent waiting for work. A “break” is a state when the agent is away from his or her station. The acronym “ACW” refers to “after-call-work” or agent processing, which occurs after a particular customer service is completed and before the agent is servicing a new customer contact.

In one embodiment, agents in a skill group may be automatically allocated to a particular sub-campaign based on a priority of each running sub-campaign. This is not a requirement, however. Thus, for example, sub-campaigns with a higher priority are given as many agents as they can use before a lower-priority sub-campaign is considered. Sub-campaigns of equal priority are allocated agents according to a number of agents that can be used (or the number of available contacts) in a next time period (e.g., 5 minutes). In the alternative, such prioritization of sub-campaigns need not be enforced across agents in a skill group, thereby enabling more equal access to the agents. The agents allocated to each sub-campaign typically changes over time as the number of available contacts changes (which affects the number of agents that can be used by each sub-campaign). Preferably, the system adjusts the rate for a sub-campaign based on several factors: the number of agents currently being used by the sub-campaign, the percentage of attempts that result in a direct connect attempt, and an average length of a successful direct connect call.

As noted above, agent allocation is not a requirement. In the alternative, agents in a skill group are either taking a call or are idle. They may receive a call from any sub-campaign currently assigned to the skill group. In this embodiment, a priority value determines if a particular sub-campaign should be dialed at a faster rate than another. This results in one sub-campaign generating more direct-connects and requiring more agents from the pool of available agents.

Typically, a skill group is based on one or more business requirements. For example, skill groups may be based on skill type, language skills, skill level, or other such factors. When a new sub-campaign is created, a skill group is assigned to that sub-campaign. The schedule for the skill group then determines the messaging rate at any given time. As more agents come on duty, typically the rate increases to keep those agents busy. When fewer agents are on duty, however, the rate decreases to avoid long hold queues for the customers. As noted above, a single skill group can be assigned to multiple sub-campaigns at the same time. Messages from each sub-campaign preferably are sent to any available agent in the skill group, so a given agent should be trained to handle messages from each of the sub-campaigns.

There may be different types of skill groups, such as a standard skill group, and an enhanced agent mode skill group. The standard skill group typically is a skill group to which a single phone number is assigned, and that number is a default phone number when there is no other number defined in the script. A standard skill group typically does not use a service-side hold queue, as defined below. With a standard skill group, agents always hang up after the client call has completed. Caller ID can be used to generate an agent screen pop-up window with the correct customer information if the client's infrastructure supports the capability. As an alternative, an audible “whisper” with customer information can be played for the agent prior to completing the connection. Agents may take advantage of a service-side hold queue to “stay-on-line” (remain connected and to receive a next customer after the last customer hangs-up, as described in more detail below). If agents remain connected, caller ID typically is not used for the screen pop-up because, typically, caller ID cannot be changed after the first call the agent's phone has been placed. If the enhanced agent mode skill group mode is used, contacts connect directly to a specific agent who has his or her own unique telephone number. Thus, when this type of skill group is configured, individual agents are added (by name) together with the associated telephone numbers. In this configuration, each agent has a unique phone number, or each agent may be set up with a different extension where one or more agents share the unique phone number. As with the standard mode configuration, agent mode skill groups use a pre-defined schedule. Individual agents, however, can each have a custom schedule or can participate in a common schedule group. The service provider can track individual agent activity in this mode, and agents use the hold queue and can stay-on-line as described above. In this mode, caller ID is not used for an agent screen pop-up window.

The system preferably executes a program to provide an agent “portal” by which an administrator (e.g., a supervisor) can administer and manage agents. The portal typically includes an agent screen, and a supervisor screen. A server component executes in the service provider system infrastructure, and a client component executes in the agent's desktop, preferably in a web browser. When the system is operating in the enhanced agent mode skill group configuration, the status of the individual agents can be viewed. This view contains information, such as the client contact with whom the agent is being connected. In this embodiment, a web page can be used as a screen pop to pass information to the agent about the contact. Typically, an agent operating in this mode has the following mutable attributes: skill group, telephone number, sub-campaign, and state (e.g., unallocated, available, busy, ACW, handoff, break, hold queue, or unavailable). The agent also can be visualized from the perspective of his or her identity, authentication information, permissions and access rights. Preferably, upon connection to the service provider or the appropriate contact center system, the agent's screen is refreshed periodically (e.g., once per second). The server-client screen pop functionality may be implemented in any convenient manner using existing technologies such as Comet, AJAX, XMPP, and the like. Comet is a WWW architecture in which a web server sends data to a client program (normally a web browser) asynchronously without any need for the client to explicitly request it. This allows for the creation of an event-driven web application. XMPP refers to eXtensible Messaging and Presence Protocol (f/k/a Jabber), which is an open, XML-based protocol for near real-time, extensible instant messaging (IM) and presence information (a/k/a buddy lists). XMPP is extensible and can support other features such as voice over IP (VoIP) and file transfer. In a representative embodiment, an agent has a telephony connection and an associated machine (e.g., a desktop computer, a laptop computer or other mobile computing device, or the like) that comprises a web browser or other rendering engine that is compatible with AJAX technologies (e.g., XHTML, XML, CSS, DOM, JSON, and the like). AJAX technologies include XHTML (Extensible HTML) and CSS (Cascading Style Sheets) for marking up and styling information, the use of DOM (Document Object Model) accessed with client-side scripting languages, the use of an XMLHttpRequest object (an API used by a scripting language) to transfer XML and other text data asynchronously to and from a server using HTTP), and use of XML or JSON (Javascript Object Notation, a lightweight data interchange format) as a format to transfer data between the server and the client.

The following describes a typical life cycle for an un-owned agent. Once an agent enters the live state, he or she is typically unallocated. Once the agent is allocated to a specific sub-campaign, he or she enters an available state. The system then establishes and maintains the persistent telephony connection to the agent, as previously described. Once a customer request occurs (a client has requested a direct-connect), the agent enters various states, such as busy. After the call is completed, the agent enters (or may enter) the ACW state, after which the agent transitions back to the available state where he or she can receive a next call.

### Preference Management Subsystem (PM)

The hosted service also includes a preference management (PM) module (or platform) that is now described. The PM system maintains a set of consumer preferences or attributes related to communication and behavior. Preferably, consumer preferences are created, maintained and accessed in one of several ways: via a web-based portal, via a voice portal, via an application programming interface (API), or via a mobile or smartphone application. The users of the preference management system typically include, without limitation, a client administrator, a client customer service representative, or the consumer himself or herself (in other words, the client's customers).

As illustrated in FIG. 3, the preference management (PM) subsystem is a component or operating module of the service provider infrastructure described above. The preference management subsystem or platform 300 comprises a core data repository 302 for storing consumer profile data according to an extensible database schema, an administrative interface 304 by which a client administrator interacts with the platform, a client web portal 306 by which client customer service representatives (CSRs) interact with the platform, a consumer web/voice portal 308 by which end user consumers (those whose preferences are being managed) interact with the platform, and an application programming interface (API) 310 by which other service provider or third party systems or applications interoperate with the platform. The platform is shared by the various user types, but each user type (role) has different access or use rights, as a function of those roles.

Generally, the PM system tracks a wide variety of consumer preferences and attributes. These include, for example:

Name (First, last, middle initial)

Address

Home Phone

Mobile Phone

Alternate Phone

Email Address

Secondary Email Address

Answers to security questions

Year of Birth

Gender

Communications Preference(s)—preferred channel, preferred time(s) of day

Communications Sent

Preferred frequency of messages

Opt'ed in to receive sales messages

Opt'ed out of sales messages

Opt-ed in to receive “______” content

Open rate on email offers

Clickthru rate on email offers

Clickthru rate on text offers

Revenue generated per email offer

Base Store

Likelihood to respond score

Customer Sat Score

Customer Value

Customer Segment

Customer Sub-segment

Avg Spend per store visit

Avg # of store visits per month

Last visit to store

Avg Spend per web visit

Avg Spend per web purchase

% of Sales/Visits

Avg # of web visits per month

Avg Spend per store visit

Avg # of store visits per month

Avg Spend per web purchase

% of Sales/Visits

Avg # of web visits per month

% of spend—web

Last visit to store

Last visit to web

Last purchase on web

Coupon redemption rate

Rebate redemption rate

# of Months as a customer

# of Months in Loyalty Program

Tier of Loyalty

Spend or purchases until next Tier

Current reward balance

Rewards/membership number

Likelihood of defection

Wallet Share

Next Reward balance due to expire

Next Reward balance expiration date

Warranty expiration

Preferred brand(s)

Preferred size, color, etc.

Account number

The following definitions apply to this disclosure:

### Administrator

This refers to an employee or other representative of the service provider client who uses the preference management platform, e.g., to configure and manage the preference management platform for the client.

### Attribute

This refers to an element of information associated with a consumer (e.g. first name, last name, account number, gender, birth date, etc., such as described above). An attribute may be “stand-alone,” or it may be associated with a subscription (e.g., “I prefer HTML email over plain-text,” or “I opt in to receive marketing messages on my home phone”). An attribute is also referred to as a Preference.

### Client

This is the service provider's customer who uses the preference management platform to maintain consumer preferences.

### Consumer

This refers to the user (or customer) of the client's product or service.

### Contact

This refers to a consumer consisting of information including Client ID, name, contact points, and other attributes.

### Contact Point

A contact point refers to an email address, phone number for voice, or phone number for text associated with a consumer.

### Customer Service Representative (CSR)

This refers to an agent or employee of the client who uses the preference management platform to view and/or edit consumer preferences.

### Event

An event is some type of occurrence of which a consumer may wish to be notified (preferably via a subscription). For example, a fraud alert, a flight delay, or an upcoming appointment.

### Preference

See Attribute.

### Subscription

A subscription is an expression of when and how a consumer wants to be notified about an event. Typically, it is an association between a consumer contact point and an event. For example, a consumer may wish to be notified via a text to their wireless number whenever their flight schedule changes. A subscription expresses a consumers desire to be communicated with via a specific contact point regarding a specific event. A subscription may also include other attributes, such as a start date and end date, or time range in which notifications may be made.

As noted above, the target users of the PM function are administrators, customer service representatives and consumers. Client administrators log into the preference management system to setup and manage preference management list, view preference management system status, run preference management reports, create or disable user logins for customer service representatives, designate a CSR as read-only (not allowed to edit attributes or subscriptions), designate a CSR as read/write (allowed to edit attributes and subscriptions, subject to access control lists (ACLs) on attributes), change passwords for customer service representatives, and generate and export a preference list on Consumer preferences. CSRs log into the platform to search for a consumer, view consumer preferences (as permitted by an access control list or ACL), and edit consumer preferences (as permitted by an ACL). Some customer service representatives may have permission to edit preferences, while others may only have permission to search for and view such preferences. Consumers log into the preference management platform to view his/her preferences (as allowed by ACLs), and to edit his/her preferences (as allowed by ACLs). The target users log into the system via a web user interface, a voice portal, or some other interface, e.g., one provided by a third party via the API.

These capabilities are described in more detail below:

### Administrator

1. Log into the preference management platform (via web or API) in an administrative role.
2. Change password.
3. Manage CSR logins.
   Create/manage/update/enable/disable.
   Read-only or read/write CSRs.
      Some read/write CSRs may be permitted to opt out but not opt in or create a subscription for a consumer.
   Preference lists associated allowed to access.
4. Manage consumer logins.
5. Create/manage/delete preference lists.
   a. List preference lists (name, description, etc.).
   b. Create contact points per consumer.
   c. Define any number of consumer attributes.
   d. Define events.
   e. Define subscriptions.
6. Run an administrative report.
   a. Audit log.
   b. CSR report.
   c. Preference list report.

### CSR

7. Log into the preference management platform in a CSR role (either read-only or read/write).
8. Change password.
9. Search for a consumer using simple search form.
10. Search for a consumer using an advanced search form (search by specific fields).
11. Browse search results; select from search results to access Consumer detail.
12. Manage a consumer's login (if permitted).
13. View a consumer's preferences.
14. Edit a consumer's preferences (if permitted).
   Create a subscription or opt in for the consumer (if permitted).
   Opt the consumer out (if permitted).

### Consumer

15. Log into the preference management platform in a Consumer role.
16. Change password.
17. View and edit contact points.
18. View and edit preferences.
19. View available events (which are available to be subscribed to).
20. Create and manage subscriptions to the available events.

### Preference Data

Preference information comprises a series of attributes associated with an individual. For convenience, preferably there are three (3) main categories of preference data, which are described below:
1. Service provider core—These correspond to the following contact fields.
   First name
   Last name
   Client ID (e.g., account number)
   Company name
   Contact Points (a set of any combination of phone number and email address)
2. Preference core—These are additional attributes associated with an individual that are not client-specific and tend not to vary frequently over time. There are two types of these:
   Subscription attributes—These are attributes defining a consumer subscription to an event. Examples include:
      Contact Point
      Opt in, opt in date, opt in method, opt in user
      Start and end dates
      Start and end times
      Maximum number of notifications
   General attributes—These are attributes that a client may want to track but are not part of a subscription. There may be many of these related to specific industries. Examples include:
      Opt out device, opt out date, opt out method, opt out user
      Sitekey—word or phrase used for mutual authentication in voice or text interactions.
      Home address (address1, address2, city, state, postal code, country)
      Date of birth
      Gender
      Credit score
      Amount due
      Date of last purchase
      Reward point balance
3. Extended preference data—These are client-specific attributes that will vary in each client's implementation of the preference management platform.

Each preference attribute (whether part of the service provider core, preference core, or extended preference data), may have certain pieces of information associated with it. These pieces of information will control when and how this preference attribute is displayed, and when and how it may be modified. For example:
Attribute name (e.g. “balance due”)
Type (string, numeric, date, boolean)
Label—this is the display name for the attribute for UI purposes.
ACL—for each role, this determines whether the field is not visible, read-only, or read/write.
Group—For use in grouping data in UI.
Priority—For use in positioning data within a group in the UI.
Parent attribute
CSR Position—this determines where in the UI grid layout this attribute should appear in the CSR view
Consumer Position—this determine where in the UI grid layout this attribute should appear in the consumer view

The above described preference data (contact data) may be arranged according to one or more “preference lists.” Preference lists live in client accounts, and a client account may have more than one preference list, and for more than one purpose.

### Events

As noted above, an event is what the consumer is opting in to (via a subscription).

Explicit support for multiple events is not required. Instead, a single type of event (per consumer) is implied, but the platform is extensible to multiple event support.
What makes up an event:
   Subscription options (allowed channels, etc.)
   Description—Answers the question What am I opting in to?
   Available start & end dates
   Type
Samples of events include:
   Flight is delayed
   Fraud detected
   Large charge against credit card (amount must be fixed without Event parameters)
   Support for a single event.
The platform also provides support for any number of events.

### Subscriptions

As noted above, a subscription binds an event to a contact point, and subscriptions can have additional attributes.

In one embodiment, support for multiple subscriptions is not required. Instead, a single subscription (per contact point) is implied for each contact point that the consumer has opted in.
What makes up a subscription:
   Pointer to an event
   Pointer to a contact point
   Schedule (start/end dates, start/end time of day, # of occurrences)
   Date subscribed
   Subscription creator name and method (e.g. web, voice, API)
The platform also provides support for multiple subscriptions and subscription instances.

The following are sample subscriptions:

### Financial

Withdrawal>$100, notify any time via text1
Charge>$200, notify between 9:00 and 17:00 via text1
Fraud detection, notify any time via voice

### Retail

Gardening offers no more than once a week, notify any time via text1
Hardware offers no more than once a week, notify any time via email1
Loyalty balance once a month, notify via email1
Store events [Unknown]
Promotions [Opted-out]
OnStar Diagnostic Alert, notify via voice1 and text1
OnStar Theft event, notify via voice1 and text1

### Utilities

Outage notification, notify any time via text1 and voice1
Invoice presentment, send via address1

### Other

Flight delayed within 1 hour, notify any time via voice1 and voice2 and text1
Flight delayed within 1 day, notify any time via email
Support for a single subscription.
Support for single subscription instance per consumer/contact point combo.

### Interfaces

The following describes a preferred embodiment of the administrator, CSR and consumer interfaces for the PM system.

As noted, an administrator can create and manage preference lists. Each preference list includes a set of attributes or preferences that will be included in that list.

Attributes include various characteristics, such as ACLs that define who may view or edit the attribute. Each preference list includes a set of events available for that preference list. Each preference list includes a set of subscriptions available for that preference list.

From the PM interface system, an administrator can create and manage new CSR user logins, create a new CSR login (should force a password change by CSR on next login), change the password for a CSR (should force a password change by CSR on next login), disable a CSR login, edit the CSR's name and contact information, and so forth. Preferably, the service provider performs a one-time bulk load of CSRs for each client, so that the client does not need to create each CSR login manually. The client provides the service provider with a file of CSRs containing all necessary fields in an agreed-upon format. As noted, some CSRs are allowed to both view and update preferences, while others may only view preferences. At CSR login creation time (and during bulk load of CSRs by the provider, as described above), CSR permissions (e.g. read-only, read/write) are designated.

An administrative console in the PM system provides quick facts about the preference management list(s) currently under management. For example, for each preference management list: the console may display or otherwise provide the following: number of active contacts, number of events, number of subscriptions, number of opt-outs. Preferably, an administrator can upload or download consumer preference lists in one or more supported formats (e.g., CSV, XML, etc.). This capability may be accessible through an API.

As noted, the CSR interface provides a CSR with the ability to search for, view, and manage consumer preferences. A CSR will log in via a service provider-based login screen. The login screen optionally is private labeled with the logo of the client. A CSR login times-out after a predetermined length of inactive time. A CSR can change his/her own password. A CSR will be forced to change their password on first login and after password change by administrator. A search for a consumer may be implemented as follows. CSRs should be able to search for consumers by any combination of the following attributes: first name, last name, account number (Client ID), phone number or email address. A consumer record may include multiple people's names. Searching by consumer name preferably should search all names in each record. Searching by name (in advanced search mode) may use Soundex (a phonetic search). Searching by telephone number preferably searches all telephone numbers in each record. Searching by email address preferably searches all email addresses in each record. The search function searches the preferences list for the client; preferably, it does not include results from any other lists that might exist in the client enterprise or account. The search results are a list of matching consumers (showing account number, first name, and last name). The CSR is then able to click on a result to view the full consumer record.

After a CSR searches for and locates a consumer (or “member”), the CSR is able to select that member and display its preference information on-screen. Preferably, the screens that display details for a particular consumer are dynamic in nature because the set of attributes is different based on the client. The set of attributes displayed for a consumer are based on both the role of the CSR and the ACL for each attribute. The CSR should not see an attribute unless the ACL for that attribute is read-only or read/write for consumers. The CSR is not able to modify an attribute unless the ACL for that attribute is read/write.

Preferably, there are several sets of information to display for a consumer: general attributes, contact points, and subscriptions. General attributes, for example, are first name, last name, account number, etc. Each attribute that the CSR has permission to see is displayed using the positioning information for that attribute to locate it on the screen. If the CSR has edit permission for an attribute, the attribute is editable. Contact points are phone numbers and email addresses, etc. The CSR can add and remove contact points, as well as edit subscriptions (subject to role and ACL permissions). If a phone number was opted-in or out by the consumer via the voice portal, the CSR can listen to the recording of the opt-in or opt-out, e.g., via a CSR web interface. After editing preferences for a consumer, the CSR is able to Save or Cancel changes to the consumer preferences record.

The consumer interface to the PM platform may be web-based, mobile-based, or voice-based. The following provides a representative implementation.

Preferably, a consumer logs-in via a service provider-based login screen. A consumer login times-out after a predetermined length of inactive time. Once a consumer logs in to the web portal, he or she is provided their preference page. This page looks like the CSR version of this page, with the following differences: the consumer only sees and is able to edit attributes for which he or she has the appropriate permissions (per the ACLs on the attributes). There is no ability to search for other consumers. The consumer can create, review, edit and update a single subscription to a single event. The consumer may also create, review, edit and update multiple subscriptions to multiple events. The preference management interface page may be framed within a client's own web pages without necessarily requiring a separate sign-in (if the consumer has already signed into the client's site).

The mobile-based application may export similar functionality, or it may use a standalone application.

The consumer voice portal allows a consumer to review and choose opt-in or opt-out status via a voice application. The consumer authenticates using identity matches that are configurable: user ID and password, match via ANI recognition, match via ANI recognition with password validation, match via Client ID capture, match via Client ID capture with password validation, etc. Using the interface, the consumer can review current subscription opt-in/opt-out status, create a simple subscription to an event (opt-in), cancel a subscription to an event, opt-out, record a verification message, and so forth.

One or more functions of the PMS may be exposed through a system application programming interface (API) to enable extensions, and/or to facilitate interoperability with customer systems if desired. The API is used for content creation (registration/update/review/delete), subscription creation (create/update/review/delete), list creation and deletion, and the like. In one embodiment, the following functionality is available via the preference management API: Authentication; Get preference list information; Get a consumer preference; Set a consumer preference; Get a full contact record, including all preference information; Generate a list based on subscriptions and other preference criteria.

Each of the following actions is logged for audit purposes: Admin login; Preference list create/delete/etc; CSR login; CSR search for consumers; CSR view consumer record; CSR edit consumer record (indicating whether by web, voice, etc.); Consumer login; Consumer edit record. An administrative user has access to the audit log via a report. (The audit log is separate and distinct from the ability to report on changes to member preferences). Administrative users also are able run the following reports: Audit log report; Preferences update report.

All consumer preference data are encrypted, and access to data is over secure communication channels (e.g., SSL, TLS, etc.).

As used herein, the preference management subsystem (platform or module) should be broadly construed to refer to machines, devices, processes, applications, utilities, software interfaces, display interfaces, configuration files, data structures and data, that facilitate one or more of the above-described functions and features.

Advantageously, the same preference management platform as described is shared by multiple entities, namely, the administrators, the CSRs and the consumers themselves. The platform is highly extensible, in that the client can define and name any field and thus include any type of additional data elements. The resulting “extended preference data” (and the associated database schema in which such data are stored) enables more sophisticated and nuanced subscriptions and thus improved acceptance and usability of the platform. As an enhancement, the observed preferences can be captured over time using the logging and reporting tools, enabling the client (through its CSR) to modify these preferences or tailor them for specific uses. Using the described interfaces, CSRs are provided the ability to create and manage preferences, but administrators can provide an added layer of control over what CSRs and consumers can view and modify. The resulting displays are logically presented and easy to use, increasing adoptability of the platform as a whole.

Preferably, a consumer also is afforded an opportunity to update preferences during a consumer interaction.

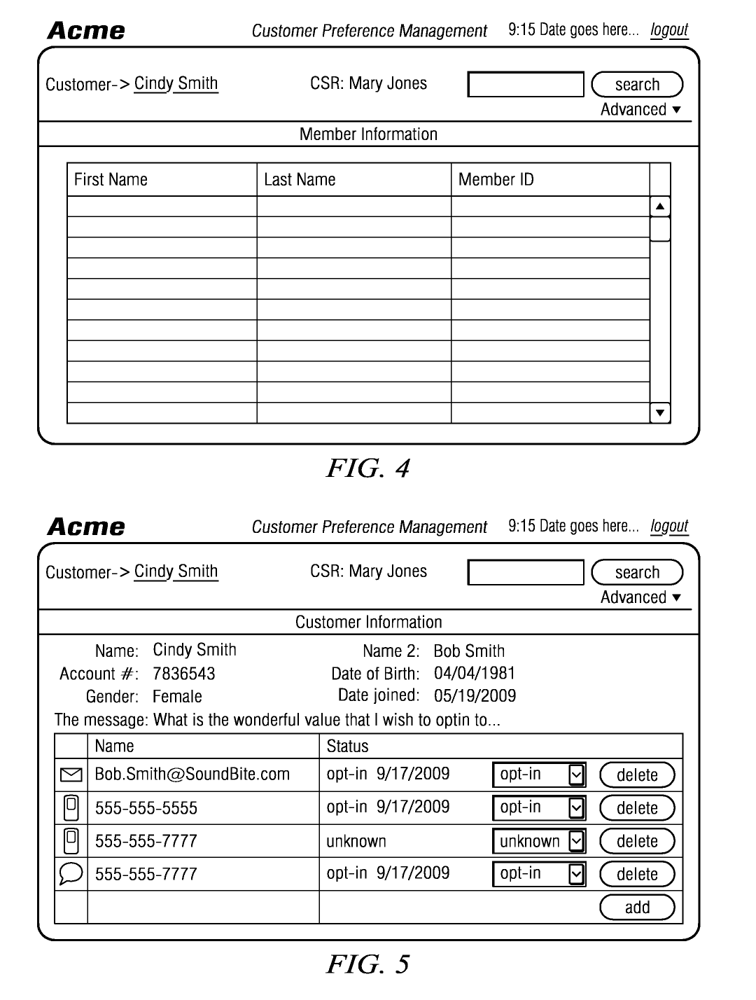

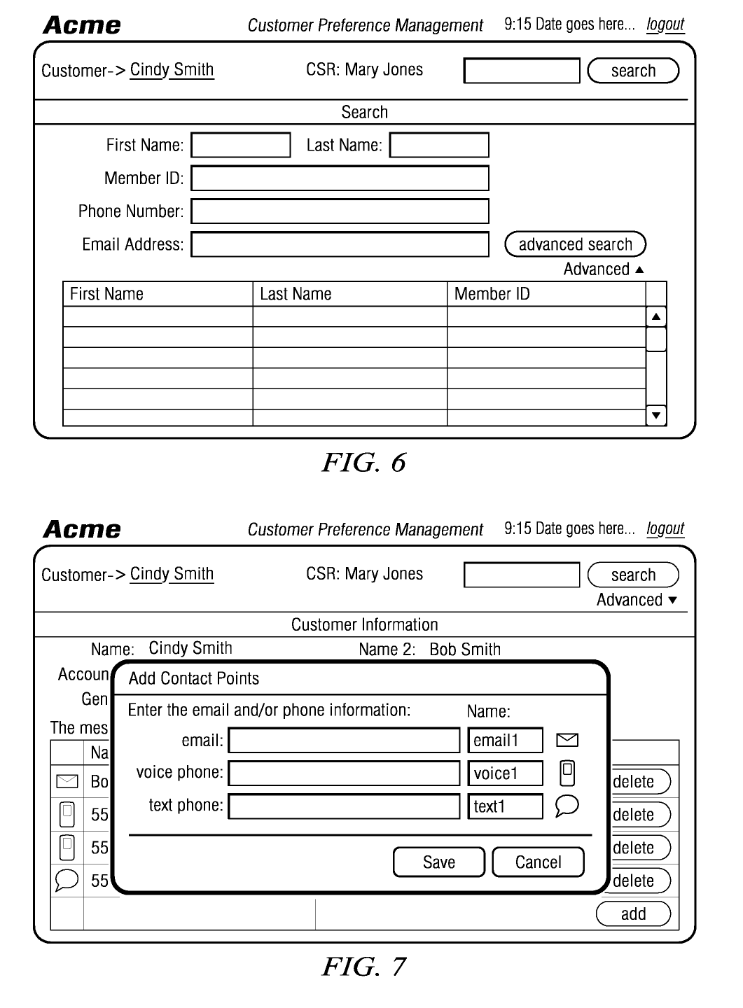

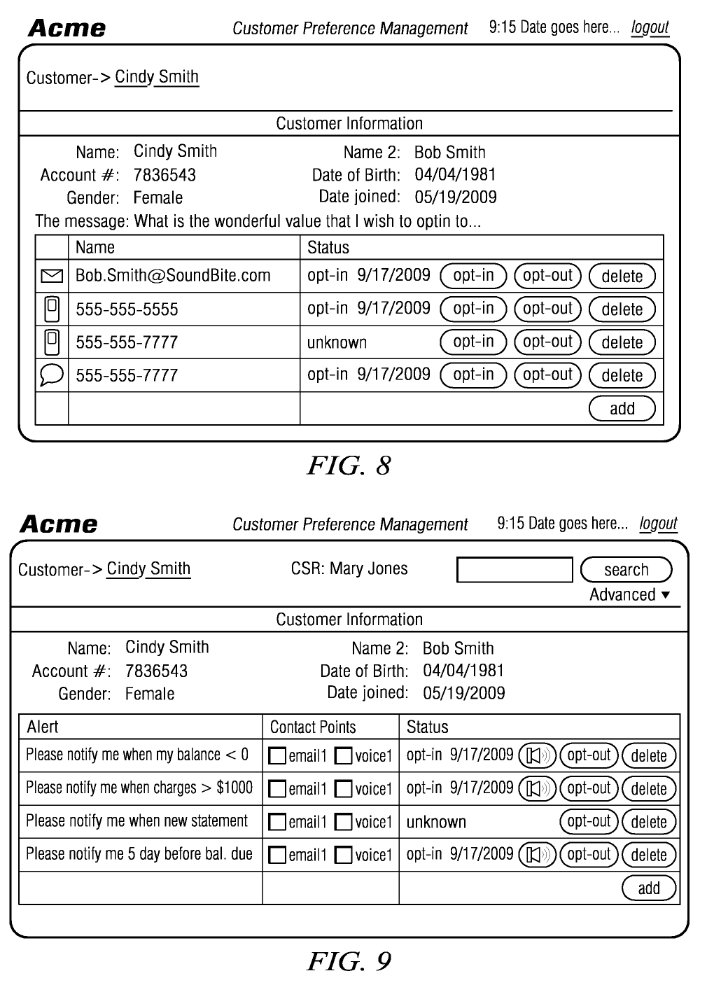

The particular display screen formats may be implemented using conventional interface tools, display widgets and objects. FIG. 4 is a representative display screen for the customer service representative. FIG. 5 is a representative display screen for the CSR to facilitate additional actions. FIG. 6 is a representative display screen for use by a CSR to perform a search. FIG. 7 is a representative display screen to enable a CSR to add contact points. FIG. 8 is a representative display screen of a consumer view. FIG. 9 is a representative display screen for use in managing subscriptions. These display formats are merely illustrative.

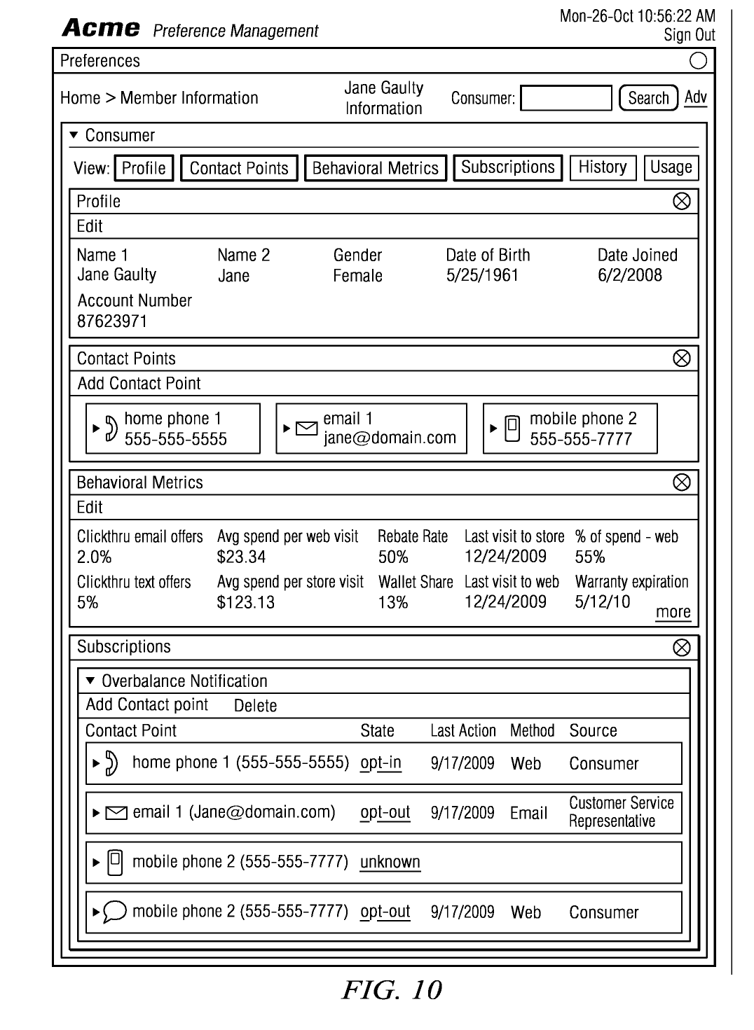

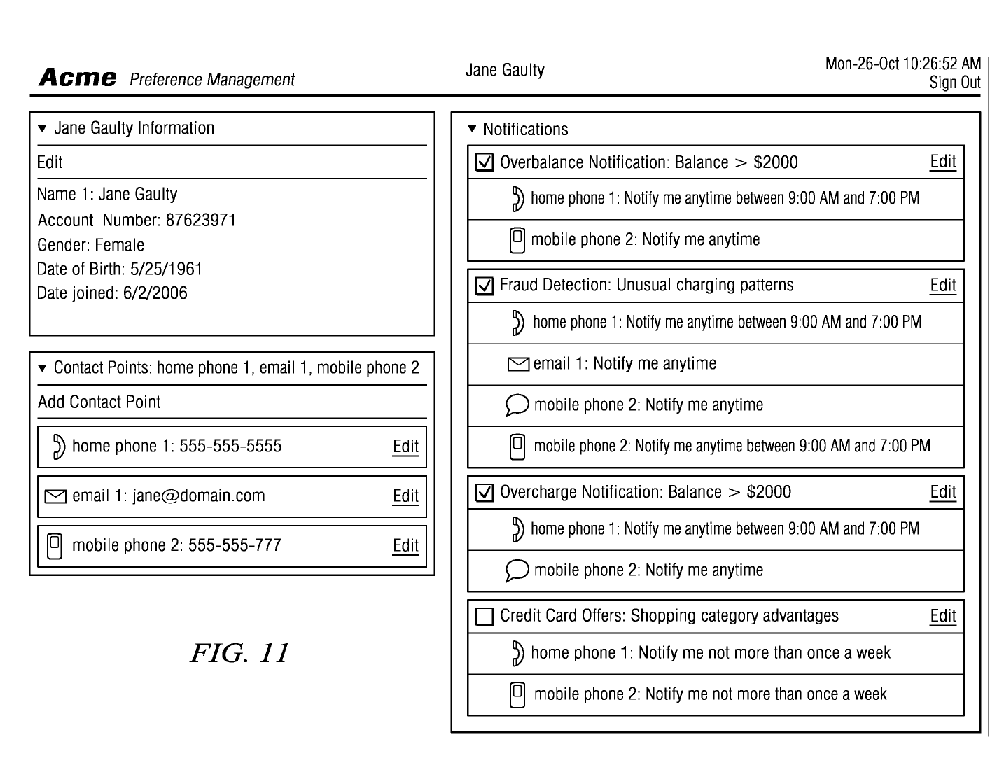

FIG. 10 illustrates a more advanced CSR interface display view. This screen identifies particular details for a given consumer. The screen includes a Profile section (or panel) with relevant consumer data, a Contact Points section by which current contact points are listed and can be edited, a Behavioral Metrics section that identifies one or more metrics that are being tracked for the consumer by the system, and a Subscriptions section that identifies the consumer's defined subscriptions. Preferably, this is an web-based interface with links to additional pages by which the CSR can edit the profile, add or edit contact points, monitor behavioral metrics (and add/edit existing fields), and view/add/edit subscriptions. FIG. 11 illustrates the display view that the consumer (identified by the page view in FIG. 10) sees when she accesses the system. This view includes the user's biographical data in an Information section, a Contact Points section identifying the currently-specified contact points, and A Notifications section identifying the current subscriptions (notifications). The page also includes links to additional pages by which the consumer can edit the various fields and add data, namely, view and edit contact points, view and edit preferences, view available events (which are available to be subscribed to), and create and manage subscriptions to the available events).

As previously noted, the hardware and software systems in which the subject matter herein is illustrated are merely representative. The described functionality may be practiced, typically in software, on one or more machines. Generalizing, a machine typically comprises commodity hardware and software, storage (e.g., disks, disk arrays, and the like) and memory (RAM, ROM, and the like). The particular machines used in the network are not a limitation. A given machine includes network interfaces and software to connect the machine to a network in the usual manner. As illustrated in FIG. 1, the subject disclosure may be implemented as a managed service (e.g., in an ASP model) using the illustrated set of machines, which are connected or connectable to one or more networks. More generally, the service is provided by an operator using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., Java applets or servlets, linkable libraries, native code, or the like, depending on platform), that provide the functionality of a given system or subsystem. As described, the service may be implemented in a standalone server, or across a distributed set of machines. Typically, a server connects to the publicly-routable Internet, a corporate intranet, a private network, or any combination thereof, depending on the desired implementation environment.

The client side of any of the above-described interfaces may implement AJAX technologies; as noted above, these include XHTML (Extensible HTML) and CSS (Cascading Style Sheets) for marking up and styling information, the use of DOM (Document Object Model) accessed with client-side scripting languages, the use of an XMLHttpRequest object (an API used by a scripting language) to transfer XML and other text data asynchronously to and from a server using HTTP), and use of XML or JSON (Javascript Object Notation, a lightweight data interchange format) as a format to transfer data between the server and the client.

Having described our invention, what we now claim is set forth below.

1. A computer program product in a computer readable medium for use in a data processing system for managing interactive communications campaigns on behalf of clients, the computer program product holding computer program instructions which when executed by the data processing system perform a method, the method comprising:
exporting an interface that is shared and accessible by a set of entities associated with each client, the set of entities including at least first and second entities each having an associated role;
storing preference data in a data repository, the preference data comprising one or more contact fields, a first set of one or more attributes that are common to at least first and second clients; and a second set of one or more attributes that are specified by a given client; and
managing the preference data in the data repository in response to requests received via the shared interface.

2. The computer program product as described in claim 1 wherein the set of entities are one of: an administrator role associated with a particular client, a customer service representative role associated with the particular client, and a consumer role associated with the particular client.

3. The computer program product as described in claim 1 wherein the interface is one: a web interface, a voice interface, and an application programming interface (API).

4. The computer program product as described in claim 1 wherein the first set of one or more attributes that are common to at least first and second clients comprise a subscription, wherein a subscription is an expression of when and how a consumer wants to be notified about an event.

5. The computer program product as described in claim 1 wherein an attribute in the second set is a custom attribute.

6. The computer program product as described in claim 1 wherein the step of managing the preference data comprises an administrator performing one of: managing an access right for a customer service representative associated with the administrator, creating a preference list, managing a preference list, deleting a preference list, defining one or more contact points per consumer, defining one or more consumer attributes, defining one or more events, and defining one or more subscriptions.

7. The computer program product as described in claim 1 wherein the step of managing the preference data comprises a customer service representative performing one of: searching for a consumer, managing an access right of a consumer, viewing a consumer's preferences, and editing a consumer's preferences.

8. The computer program product as described in claim 1 wherein the step of managing the preference data comprises a consumer performing one of: viewing and editing contact points, viewing and editing preferences, viewing events, and creating and managing subscriptions to events.
